(19) United States
(12) Patent Application Publication
(10) Pub. No.: US 2020/0140214 A1
(43) Pub. Date: May 7, 2020

(54) EXPEDITIONARY HEAVY ARMOR RAMP SYSTEM

(71) Applicant: WINDLESORA LTD, Bloxwich (GB)

(72) Inventor: Andrew Gunn, Windsor (GB)

(21) Appl. No.: 16/546,031

(22) Filed: Aug. 20, 2019

Related U.S. Application Data
(60) Provisional application No. 62/720,028, filed on Aug. 20, 2018.

(51) Int. Cl. B65G 69/28; B65G 69/30

(52) U.S. Cl. CPC B65G 69/2864; B65G 69/30

(57) ABSTRACT

A military deployable ramp system assembled from sectional modules and used to load/unload heavy wheeled and tracked vehicles on/off rail cars and other transport platforms. The design of the system affords potential to handle such vehicles in a wide range of environments, particularly at remote train track locations. The assembled modular ramp consists of two main parallel load-bearing ramp tracks, connected to each other via central bridging supports. Sections slide together vertically and connect using structural angles which are retained in opposing guide channels, eliminating the need for fixing hardware. Once assembled the ramp can be dismantled by lifting off each section clear of the others in order. The ramp sections independently find their own level relative to each other on unprepared ground. Additional restraint is provided by integrated lashing points for sections to be tethered together to enhance its assembled rigidity.

### CROSS-REFERENCE TO RELATED APPLICATIONS

This application claims priority to and the benefit of the filing of U.S. Provisional Patent Application No. 62/720,028, titled “Expeditionary Heavy Armor Ramp System”, filed Aug. 20, 2018, and the specification and claims thereof are incorporated herein by reference.

### BACKGROUND OF THE INNOVATION

Military vehicles, and heavy vehicular equipment generally, are expensive and scarce resources that benefit from easy portability to react to changing environments, threats, disasters or other contingencies. The easier such equipment can move via multi-modal transportation, the more effective the assets are. To leverage existing rail networks especially, military planners and logisticians require a flexible and deployable ramp capability that does not presently exist to load or unload rail carriages wherever their requirements dictate, rather than at fixed terminal locations.

One embodiment of the present invention relates to a heavy-duty modular ramp system designed to load and unload (primarily military) wheeled and tracked vehicles to and from rail cars (and other transport trailers and docks). The embodiment allows smaller more manageable modular ramp sections (also referred to herein as ‘modules’) to be transported to the point of need and assembled into a substantial capacity ramp formed of multiple pieces. This allows vehicles, up to and including the heaviest armored battle tanks, to be unloaded from rail cars or trailers to the ground level where they can be fully utilized. The one or more embodiment therefore enables the establishment of impromptu heavy freight terminals without requiring fixed location/permanent cranes or local dock or ramp facilities which may be scarce or non-existent.

Existing ramps for the loading and unloading of rail cars are predominantly permanent concrete constructions at dedicated rail terminal facilities. Portable ramps that have been built bespoke for this purpose suffer from various challenges. Their typically heavy single-piece construction reduces mobility even within a yard itself, creating a dependence on heavy lifting equipment just to manoeuvre the existing portable ramp. So the “portable ramps” are rarely moved, or if they are moved, the portable ramps are not moved far because of the weight of the portable ramps and the equipment required to move the portable ramps. Their size, shape and weight make rapid movement by land, sea and air either logistically impractical or impossible. The existing portable ramps also require a flat surface on which to operate, meaning they are further unsuited to operation in remote and austere areas where the terrain at the unloading location is not flat or of a surface grade sufficient to accommodate/use existing “portable ramps”. Existing portable ramps typically require near flat solid surfaces on which to operate for heavy equipment. They are also typically constructed to deal only with a specific height of rail car with limited or no adjustability in height. Such heavy ramps as therefore exist have been primarily designed for, and are limited to, increasing the throughput of rail movement within the boundaries of existing military and civilian rail facilities, rather than to increase ramp portability more widely outside of these dedicated facilities.

Portable vehicle loading ramps generally—e.g. forklift loading ramps—are commonplace in transportation yards. They allow for more loading flexibility, since such devices are not fixed to a location and can be moved more easily within a yard by towing, and also between yards by road with specialized transportation. However, they still fall far short of the weight capacity required to handle heavy wheeled and tracked vehicles, such as main battle tanks. The physical size and shape of a ramp required to support modern battle tanks and other tracked vehicles (e.g. excavators) renders road transportation between sites either expensive, impractical or impossible. Furthermore, to increase the load bearing capacity of a typical heavy-duty yard ramp to support loads in excess of 185,000 lbs in weight renders the technology and approaches of existing ramp systems wholly unsuitable for the present application.

Related art to this invention is therefore limited to portable ramps that are fabricated structures designed for heavy armor applications. Examples are scarce. They are very large and heavy to transport, and whilst they are technically (or hypothetically) portable, they remain static in fixed locations only at dedicated rail or road terminals to boost capacity and move around solely within the terminals themselves. As such they are typically made to meet the needs of a specific height of prevalent rail car only, without any height adjustability, just like a concrete dock. This means that rail cars can still only be loaded and unloaded at pre-determined and fixed geographical locations which negatively impacts military planning and the deployment of vehicles inter- and intra-theatre. These challenges limit the scope of rail for military deployments and force a reliance on other transport methods due to this lack of flexible capability.

Furthermore, the reason why military planners in particular desire to move away from reliance on fixed locations of loading/unloading is inherent in the nature of the combat threat. If an enemy engages in such a manner as to frustrate existing logistics plans, then combatant commanders require alternative methods to offload vehicles from railcars that are simple to transport into place, flexible in their use, and effective at the fullest loading capacities. None of the prior art ramp systems meet any of these criteria.

### SUMMARY OF THE INVENTION

One embodiment of the present invention provides for an assembled modular ramp system that comprises a first outer ramp track and a second outer ramp track. A central bridging support connects the first outer ramp track with the second outer ramp track. The first outer ramp track and the second outer ramp track comprise a plurality of ramp modules having differing vertical lifts such that the first outer ramp track and the second outer ramp track have a like sequence of vertical lifts provided by the plurality of ramp modules that decrease from a height of about a loading dock to about the off-loading surface. A ramp module of the plurality of ramp modules is configured to interlock with an adjoining ramp module. The central bridging support comprises one or more support members that connect a ramp module of height x positioned in the first outer ramp track to the ramp module of height y positioned in the second outer ramp track at an equivalent position to the ramp module of height x so as to stabilize the assembled modular ramp system. If the ramp module of height x and the ramp module of height y are positioned on level ground then height x and height y may be equal. In contrast, if the ramp module of height x and the ramp module of height y are not positioned on level ground then height x and height y may be unequal. The position of the ramp module of height x and the ramp module of height y may be adjacent as in 107 and 107′ and/or may be near as in ramp module 107 and 106′. Further, the ramp module may have one or more pockets to accept forklift tines, one or more slinging points to which lifting equipment can be attached. Further each ramp module in the first outer ramp track or the second outer ramp track is a different vertical lift as compared to the adjoining ramp module while maintaining at all times the same loading angle. The ramp module can be comprised of heavy structural steel. In one embodiment, the upper surface of the ramp module is provided with a slip-resistant coating. In another embodiment a lashing/tie-down position is affixed to the ramp system.

For example, the upper surface is comprised of steel affixed with an arrangement of solid bar sections to increase friction for a vehicle's wheels or tracks. Further, the solid bar sections are affixed at an angle other than horizontal to allow for water run off from the upper surface. Further still, the ramp module in the disassembled state may be inverted and packed together with an opposing ramp module upper surface to upper surface in their angled planes, wherein the angled solid bar rests and opposes that of a mating ramp module to form a triangular shaped module wherein the triangular shaped modules is prevented from sliding apart. The plurality of ramp modules may comprise lashing points to securely fasten the plurality of ramp modules together.

In one embodiment, each support member has a first end and a second end where the first end is connected to the ramp module of height x in the first outer ramp track and the second end is connected to the ramp module of height x in the second outer ramp track with a plurality of pins or other fixing means to avoid rotation of a joint. In one embodiment each ramp module is constructed from a separate base frame and an upper wedge to create an angled upper driving surface. The ramp module wedge can be bolted to a separate base frame using a multitude of fixing positions. For example, the ramp module wedge is positioned laterally to move the driving surface relative to the ramp base frame. The interlock of adjoining ramp modules comprises a flanged channel guide positioned longitudinally at a lesser side of the ramp module, and over which is positioned an opposing angled section located on a greater side of an adjoining ramp module and wherein the flanged channel guide is configured to enclose over the opposing angled section of the adjoining ramp module, wherein the flanged channel permits vertical travel of an outward facing plate of the opposing angled section within the flanged channel but which prevents the opposing angled section from disconnecting laterally or longitudinally under load without first lifting in the vertical plane of the adjoining ramp module. The outer ramp module is laterally connected to each other via an arrangement of structural sections connected back to the modules by brackets presenting latitudinally in the outer ramp modules wherein the bracing members are pinned in place using a plurality of pins at either end to prevent rotation of the connection joint.

It is an aspect object of tone embodiment of the present invention to provide a flexible and heavy-capacity modular ramp system that may be easily transported by land, sea or air to the point of need, whether that be used to load or unload rail cars or road trailers. This aspect/object, and others to become apparent as the specification progresses, is accomplished by the invention which, briefly stated, comprises two main parallel load bearing ramp track assemblies, connected to each other by central bridging supports one embodiment provides the load bearing capacity of the modular ramp to support loads of 185,000 lbs or more. Each ramp track assembly is comprised of a plurality of ramp modules which grow progressively from the lowest to highest ramp heights required by the user.

In one aspect of one embodiment of the present invention, ramp modules connect by the process of sliding together vertically, with structural angle sections being retained in opposing structural section channels or guides. Additional restraint is provided by integrated lashing points for sections to be tethered together to enhance rigidity and structural performance. The sliding method of connection between modules allows each module to self-level to the ground, eliminating or reducing the need to brace or shim the overall ramp on ground which may not be flat.

In cases where the ramps are not as aforementioned large constructions, according to a preferred embodiment of the invention, the plurality of modular sections may be handled with greater ease and have a lesser transport footprint when placed onto the transport vehicles, with preferentially one embodiment of the present invention being designed to break down and ship complete in a single 20 ft ISO intermodal shipping container. Such a simplification facilitates transportation of the ramp components via more multifarious transport vehicle types—including air shipment—as may be more readily available, compared with larger specialist transport methods as are required for single piece ramps. In addition to the more ready availability of the transport options to move the invention, the smaller size of the individual invention sections and corresponding smaller vehicle footprints required may facilitate said transport reaching more remote or austere or tactical military environments, which may not be accessible by the heavy transporters required in the aforementioned large ramps.

In the case of known vehicle loading ramps that are height adjustable, existing ramps address the vertical adjustability typically via telescopic support legs underneath the ramps that allow the finishing loading height/vertical lift to be varied by the pivoting or varying the angle of the ramp. In creating differing heights, such ramps require vertical supports and vehicular movements apply considerable downward forces onto these support legs which concentrate the loads to their base and are as such only suitable for strong base ground, such as concrete. Their flexibility in creating different loading heights comes with the trade-off of the ramp approach angle varying with height, creating the steepest angles to reach the highest loading positions, which would benefit from gentler approach angles to cope with the weights and operational safety risks involved in loading heavy armored vehicles. Preferentially, according to a preferred embodiment of the present invention, the method of height adjustment in the ramp system maintains an optimal constant loading angle at all heights, with the entire ramp base structure spreading its load to the ground at all points, allowing it to maintain safe operation in a much wider range of operational environments and ground conditions—such as around rail track—and allowing much higher weight capacities to be thereby achieved. Such a simplification applies to all the embodiments of the invention.

According to a preferred embodiment of the invention, ramp sections may affix to each other longitudinally via an arrangement of angle sections which may be retained by, and affix in place by interference with, the structural section channel in the module adjacent. The section angles and channel guides are so designed and/or arranged that the coupling to the adjacent member may be engaged simply from above with the modules of the ramp being built into the ultimate assembly via an arrangement of lifts of the ramp modules into position. Preferentially this sliding channel and guide arrangement simplifies the assembly of the ramp modules by eliminating or reducing the need for fixing hardware (e.g. nuts or bolts) on the main ramp assemblies and the associated tools, training and instruction this would require. Such a simplification applies to all the embodiments of the invention.

According to a further feature of the invention, each of the individual ramp sections is designed to accommodate lifting into position using a wide range of standard lifting resources as may be widely available—for instance forklift, crane, excavator, or a block and tackle—by the integration of heavy structural slinging points integral to the modules.

According to a preferred embodiment of the invention, the main ramp modules are designed to rest adjacent to, but not on, the rail track itself. This possibility is afforded to the invention by the central arrangement of bridging members which retain the main ramp members laterally by a simple pinned mechanism, with such spacing being set at an optimum distance apart to function regardless of the worldwide railway gauges which may encountered (specifically ‘standard’ and ‘broad’ gauges).

According to a further feature of an embodiment of the present invention, the central bridging members which affix to the inside sides of the ramp modules via pins serve to provide sufficient lateral and torsional stability to eliminate the need to anchor the ramp to the ground, despite the heavy loads. Where the ramp is used other than on rail track environment, for instance as a flexible vehicle loading ramp in a yard, the central bridging members may equally be used to eliminate the need for anchoring the ramp modules to the ground.

As an additional feature of the invention, the connection method of the main ramp members is conceived to afford flexible loading heights by the selective use of fewer than the complete set of ramp modules to create progressively lower loading levels. Preferentially, unlike fixed loading ramps which have fixed heights, or other adjustable ramp technology which suffer from weight restrictions, using progressively growing ramp sections to achieve staggered loading heights allows the invention to be used flexibly in a wider range of conditions and still achieving maximum loading weight performance and a constant optimal loading approach angle.

Furthermore, the minimal nature of the central bracing sections permits access to the central ramp voids to permit cross-tensioning of the outer parallel ramp sections back to each other in optionally horizontal and diagonal methods as may be effected to provide additional rigidity to the assembly, and which as a preferred embodiment of the design the positioning and encompassing of said tensioned chains or straps internally to the ramp assembly via an arrangement of tethering points may avoid any vehicular interference or damage to the straps during operation of the ramp, or which may avoid the possibility of tripping of personnel operating in the vicinity. Similarly, tethering points may be provided on the outer sides of the ramp modules with the purpose to prevent the ramp system or train/trailer from moving in operation.

As an additional feature of one embodiment of the present invention, the parallel ramp sections may benefit from an inclined surface to which may be applied anti-slip treatments, which may comprise, but not be limited to, additional steel sections affixed to the surface in such a manner as to provide additional traction capability for wheeled or tracked vehicles using the ramp. Such sections may additionally be angled to provide for water run-off and preferentially avoiding water or liquid build-up that may freeze or otherwise permit loss of surface traction.

As a feature of an embodiment of the present invention, the primary application is to facilitate the movement of heavy wheeled and tracked vehicles traversing on and off rail cars and transport trailers, and the main outer ramp track sections may be primarily sized for this application as regards to the track widths in the latitudinal plane. However, as an additional feature of one embodiment of the present invention the main ramp modules may be installed in a standalone configuration, bolted to the floor, to be used as a moveable loading ramp or dock ramp, and without necessarily requiring the central bridging supports. In such a manner, the track width of the ramp may be altered to suit the application, allowing more flexibility of use. As an additional feature of one embodiment of the present invention, the main ramp surface being bolted to the ramp sub-frame may be removed for routine maintenance, such as repainting, in a simple manner, with preferentially the smaller ramp sections, when broken down into sub-assemblies, being simpler to maintain than larger single piece ramp systems.

One aspect of an embodiment of the present invention provides that the ramp modules are comprised of base sections and upper wedge shaped sections which are for example, bolted together to form rigid structural assemblies. Preferentially the wedges allow the ramp surface to project or cantilever partially over a rail track, while the module bases remain either side of the track. The wedges allow for lateral adjustment by bolting the wedge shaped section in a different configuration such that the ramp surface is aligned centrally over the ramp module, such as in a loading dock configuration.

It will be understood that the above description of the embodiments of the present invention is susceptible to various modifications, changes and adaptations, and the same are intended to be comprehended within the meaning and range of equivalents of the appended claims. Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

The present invention will become more fully understood from the detailed description and the accompanying drawings, wherein:

FIG. 1 shows a functional ramp system in its assembled state according to one embodiment of the present invention

FIG. 2 shows the ramp system disassembled into its main functional modules according to one embodiment of the present invention.

FIG. 3 shows the ramp system of FIG. 1 packed into a single 20 ft ISO intermodal shipping container according to one embodiment of the present invention.

FIG. 4 shows a ramp according to one embodiment of the present invention in use astride the railway tracks

FIG. 5 shows a ramp according to one embodiment of the present invention in use at a rail crossing

FIG. 6 shows a ramp according to one embodiment of the present invention in use loading a road trailer

FIG. 7 shows the main parallel load-bearing ramp sections in their complete form, including all vertical heights and toe sections for flush loading, along with the central bridging supports, according to one embodiment of the present invention.

FIGS. 8A-D show one main ramp assembly having been built up, before the adjacent assembly is set in place, and which is braced laterally by way of the central bridging supports, and further supported by tethering hardware allowing connection back to the rail car or trailer via a tether, according to one embodiment of the present invention.

FIG. 9 shows the outer ramp tracks being arranged either side of a variety of prevalent worldwide track gauges, making the ramp system suitable for global usage, according to one embodiment of the present invention.

FIG. 10 shows a ramp module being lifted via a plurality of slinging points, according to one embodiment of the present invention.

FIG. 11 shows the longitudinal ramp module connection detail allowing each ramp module to slide securely into the structural guides and down the channel, preventing module separation or rotation, according to one embodiment of the present invention.

FIGS. 12A-B show the structural angle and channel connection detail and its lifting method, according to one embodiment of the present invention.

FIG. 13 shows the main ramp module construction from the base support framework to the structural wedges which may be bolted into different positions on top to adjust the track width of the ramp, as well as to facilitate easier shipping and maintenance for the ramp system, according to one embodiment of the present invention.

FIG. 14 shows the ramp system configured to be used in one mode as a static ramp that can be configured for different track widths by simply setting it to the desired offset distance, according to one embodiment of the present invention.

FIG. 15 shows the ramp system being used by a variety of different vehicle types, according to one embodiment of the present invention.

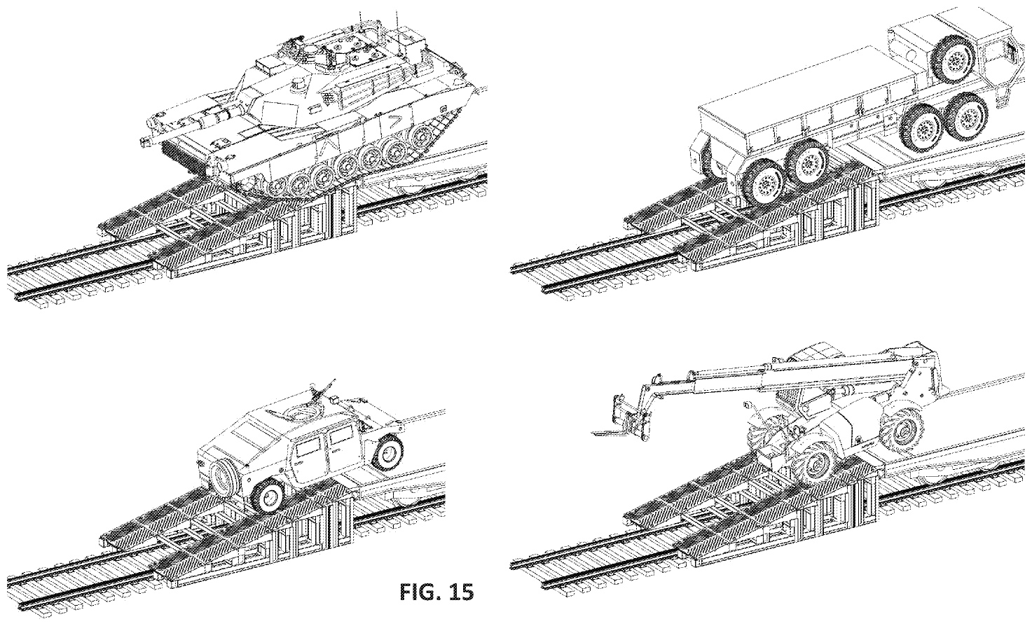

FIG. 16 shows the ramp system supporting multiple varieties of vehicle track widths, from main battle tanks, heavy transporters, to tactical vehicles and large forklifts.

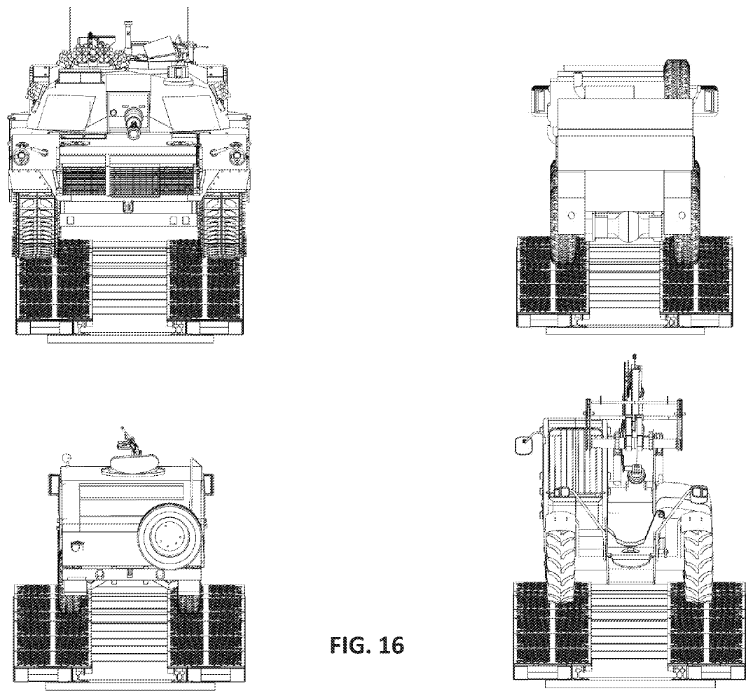

### DESCRIPTION OF THE PREFERRED EMBODIMENTS

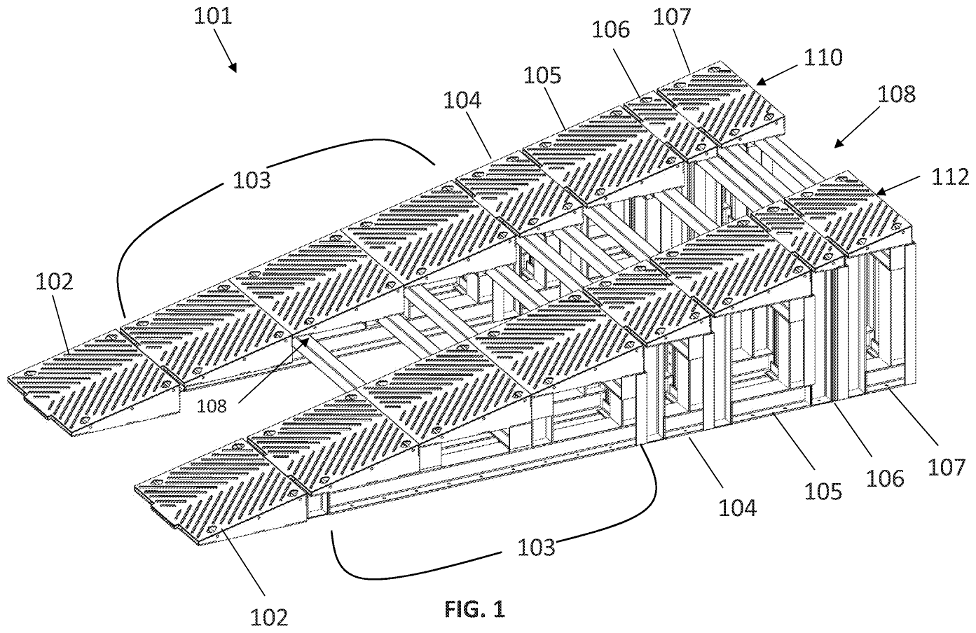

Turning to the embodiment illustrated in FIG. 1, there is shown a plurality of ramp modules 102, 103, 104, 105, 106, 107, and support members 108 which are assembled to form a modular ramp system 101. Each ramp module has a greater end and a lesser end referring to the height from the bottom of the base of the frame. For example, the greater end of ramp module 107 is adjacent to the dock, trailer, rail car or other platform from which to load or unload cargo. The lesser side of ramp module 107 is adjoining ramp module 106. First outer ramp track 110 and second outer ramp track 112 are stabilized with support member 108 that connects each ramp module that is directly across from each other such as ramp module 107 on first outer ramp track 110 with ramp module 107 on second outer ramp track 112.

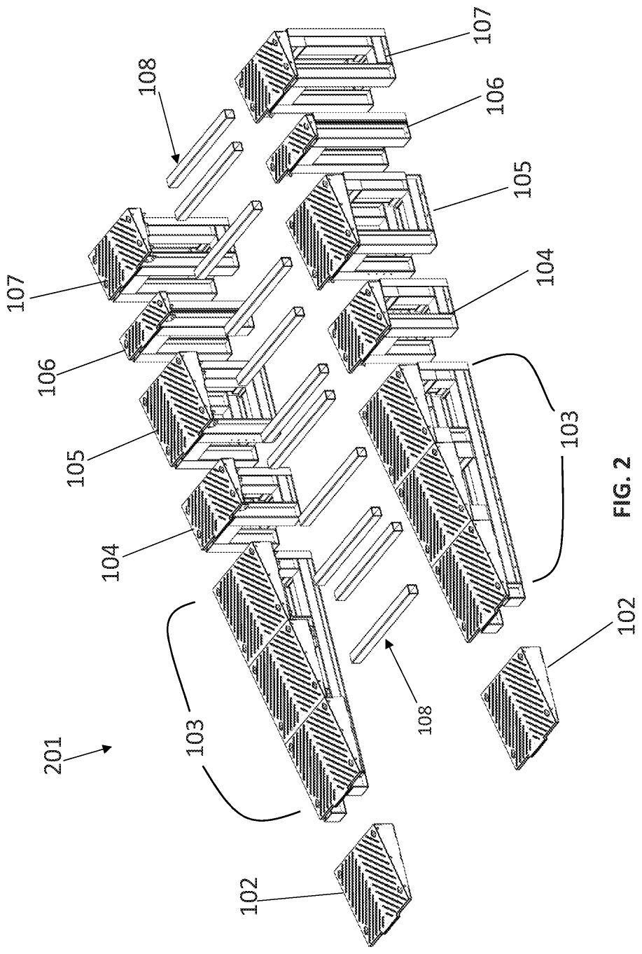

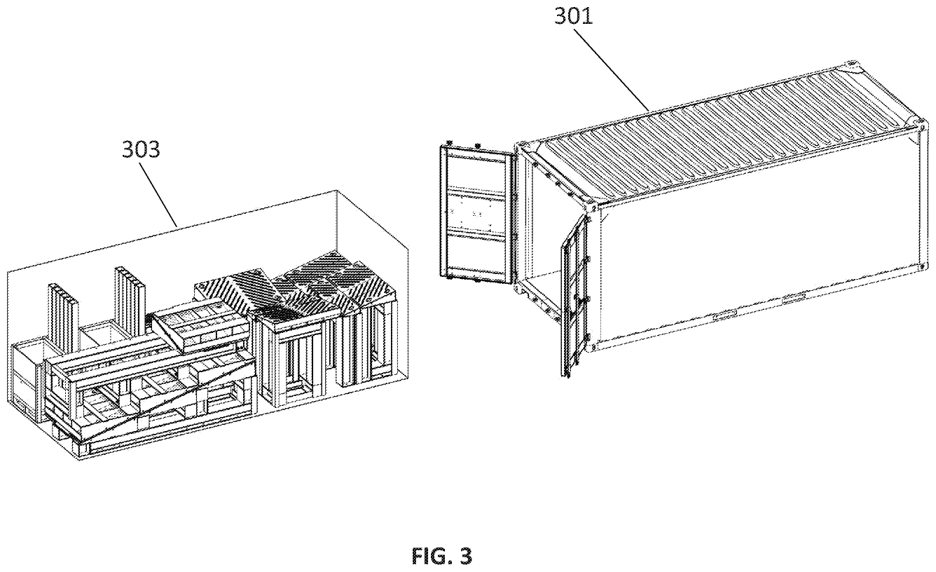

FIG. 2 demonstrates the ramp system 201 disassembled into the individual ramp system elements including ramp modules 102, 103, 104, 105, 106, 107, and a plurality of central bridging support members 108 which may be consolidated for transport into a single 20 ft intermodal ISO shipping container 301 as illustrated in FIG. 3 for ease of movement between sites with the individual elements of a complete ramp system contained entirely therein 303. In one embodiment, ramp module 103 is a combination of multiple ramp modules to form single ramp module 103.

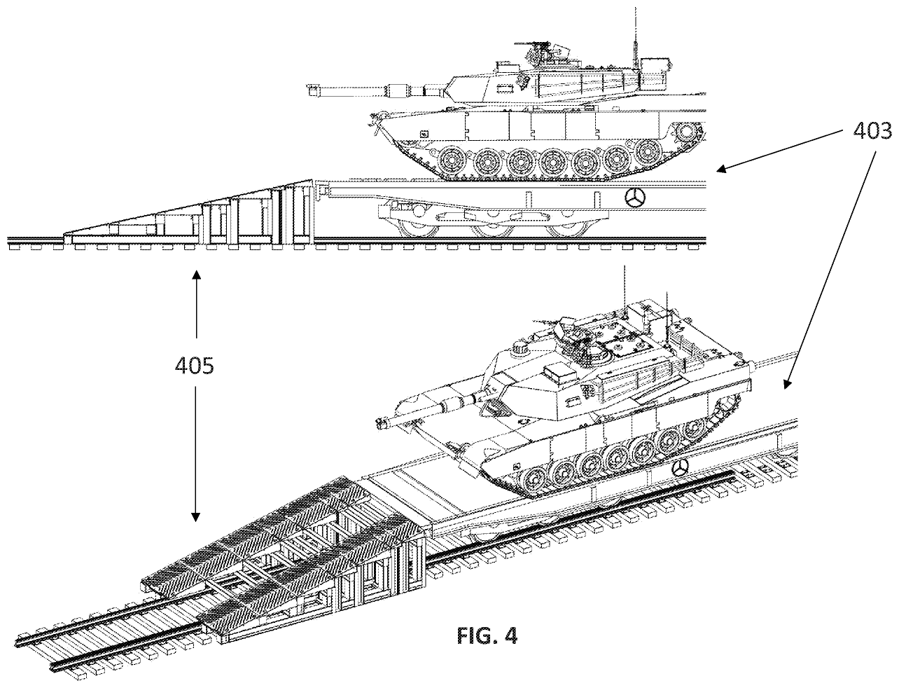

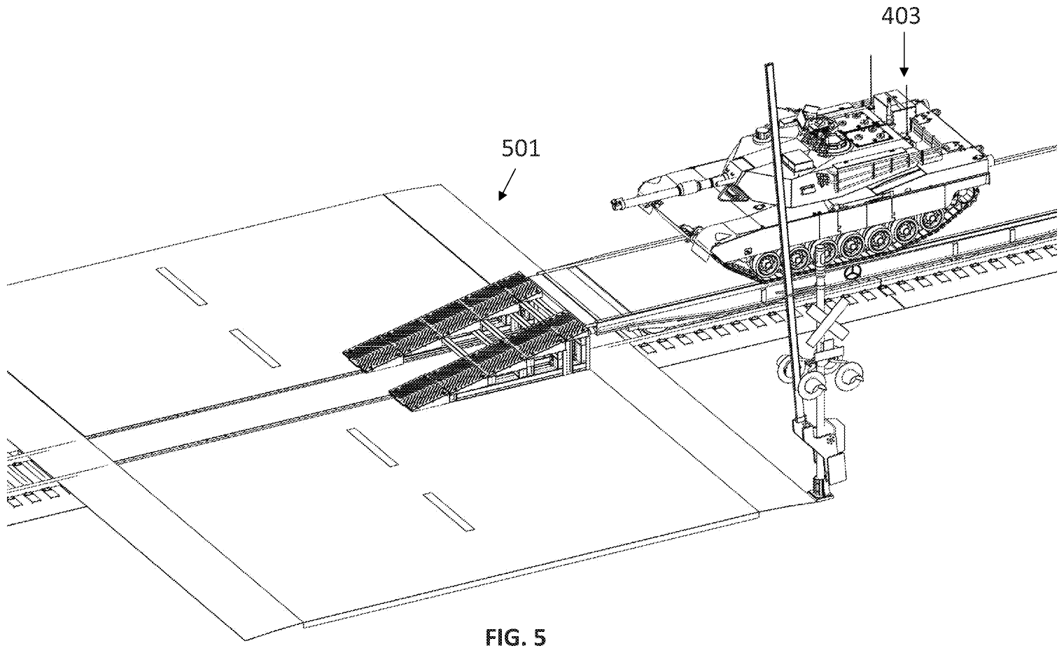

According to one embodiment of the present invention, the ramp system 405 is designed to operate as illustrated in FIG. 4 and FIG. 5 at the rear of a rail car 403 whether said rail car is at a road crossing point 501 (FIG. 5) or alternatively astride the tracks themselves 405.

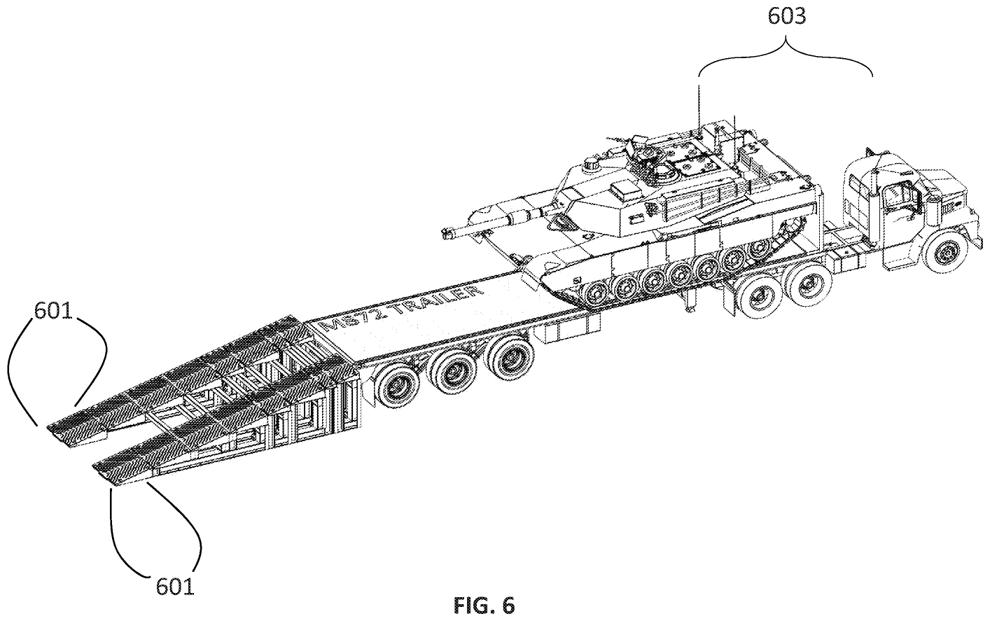

Referring now to FIG. 6, the modular ramp system is further designed to function when loading or offloading heavy transport trailers 603 by the use of the ramp toe wedges 601.

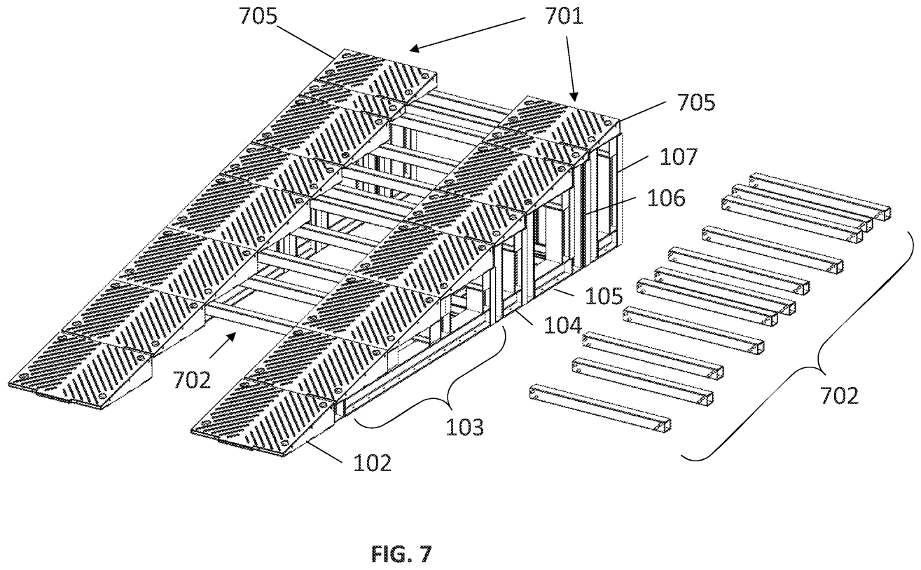

Referring now to FIG. 7, a ramp according to one embodiment of the present invention is formed of two parallel outer ramp track sections 701 forming the main weight bearing members of the ramp to receive the wheeled or tracked vehicle. The outer ramp track section 701 is braced and supported by central bridging support 702 which provides lateral and torsional stability to the interconnected ramp modules of the outer ramp track sections 102, 103, 104, 105, 106 and 107.

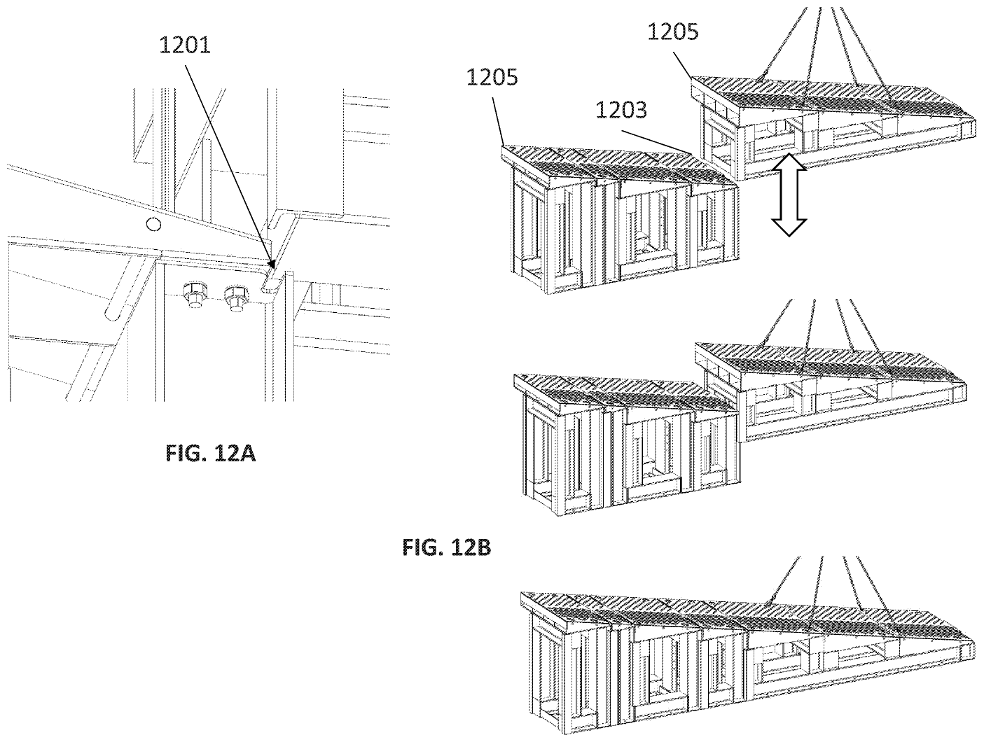

According to one embodiment, each outer ramp track 701 of FIG. 7 is comprised of structural steel members configured and arranged in combination to provide heavy duty load bearing support (for example load bearing that is sufficient to offload weights of 185,000 lbs for example a military vehicle that weights 60-74 tons, 50-60 tons, greater than 1500 lbs to several tons) to an upper plate surface 705, which provides the bearing support to the vehicle. Each ramp module 102, 103, 104, 105, 106 and 107 has an upper plate surface 705. The outer ramp track 701 ramp modules also connect in order of height/vertical lift from the tallest to the shortest by a process of lifting of the sections into position (see FIGS. 12A-B). The vertical lift of the ramp module is measured when the ramp module is in position on the ground where it is to be positioned. This permits each outer ramp track to be customized with the proper height ramp module to accommodate for uneven ground and permit the desired loading angel of the ramp. Each outer ramp module may also feature brackets or other connecting hardware to their inside sides which face the opposite parallel ramp module inside side, such brackets purpose being to affix the central bridging supports.

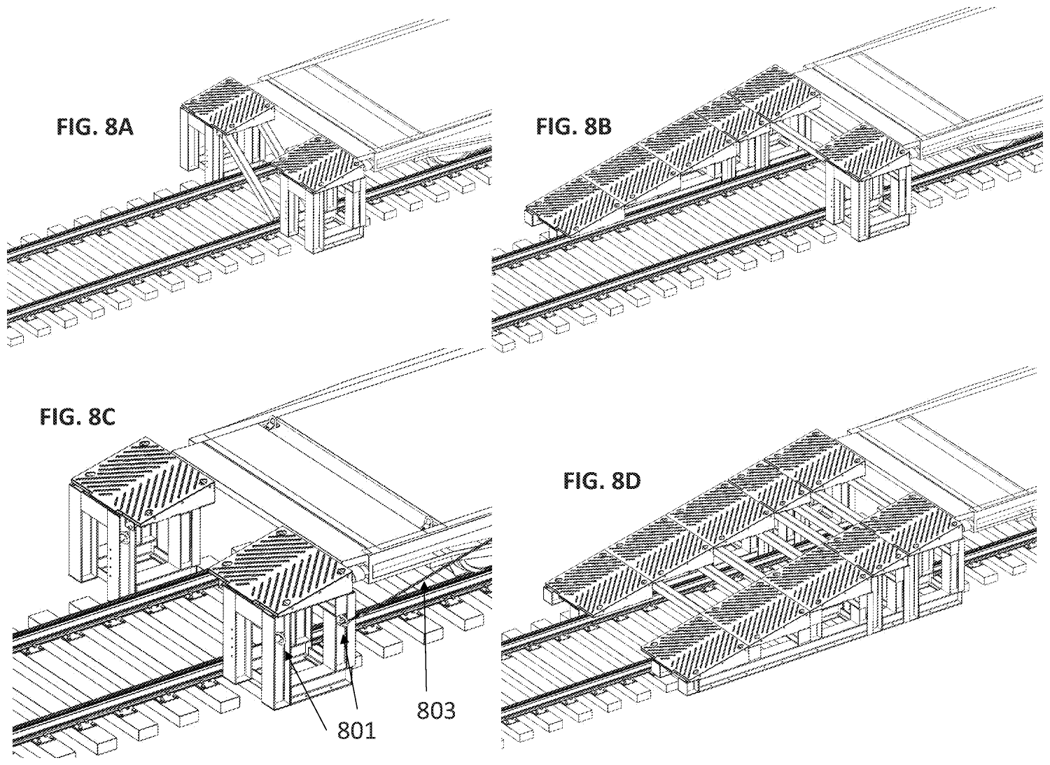

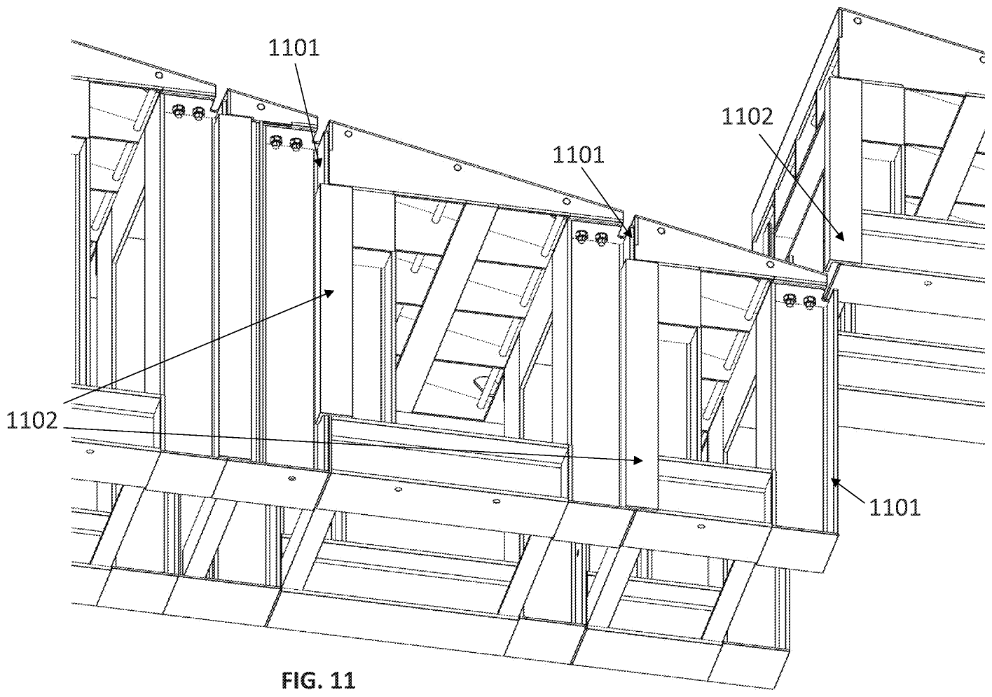

The tallest required outer ramp track section (which determines the loading height of the ramp) is lifted into the intended position adjacent to the dock, railcar or trailer (see FIG. 8A). At this point the module may be tethered via tethering hardware 801 and tether 803 securely to prevent the ramp or railcar/trailer from shifting during operation. The next tallest ramp module is lifted and positioned over an intended resting position such that the next tallest ramp module fully clears vertically of the tallest ramp module that is already in position and to which the lowered ramp module will connect (see FIGS. 12A-B) in such a manner as to allow the opposing angle section 1102 on the greater end 1205 of the ramp modules 701 to slide through a cut-out guide 1101 (for example a flanged channel) on the lesser end 1203 of the taller module and be thereby encapsulated by the taller module's cut-out guide (eg. structural beam flanges) 1101 in a strong manner, but such as to still allow an amount of relative movement and flexibility for each module thereby connected (see FIG. 11). The length of travel of angle 1102 in the flange channel 1101 is not a precise distance to achieve the strength of the module connection, with the design strength being achieved through the vertically locked interference, preventing module separation. Each module can therefore find its own final levelness even on ground which may not be fully level, without compromise to the overall performance of the modular ramp system.

The same connection method is employed on each ramp module of the outer ramp track assembly 701, with the process of assembling the outer track section continuing in the aforementioned manner from the tallest to the shortest in height in that order. The angles 1102 becoming entrapped within their neighbouring modules 1101 in such a manner that the assembled ramp when complete may only be dismantled by first lifting sections out fully clear vertically of their neighbouring sections. Correspondingly all the ramp system modules form a rigid assembly by virtue of the interference between their constituent parts, according to one preferred embodiment.

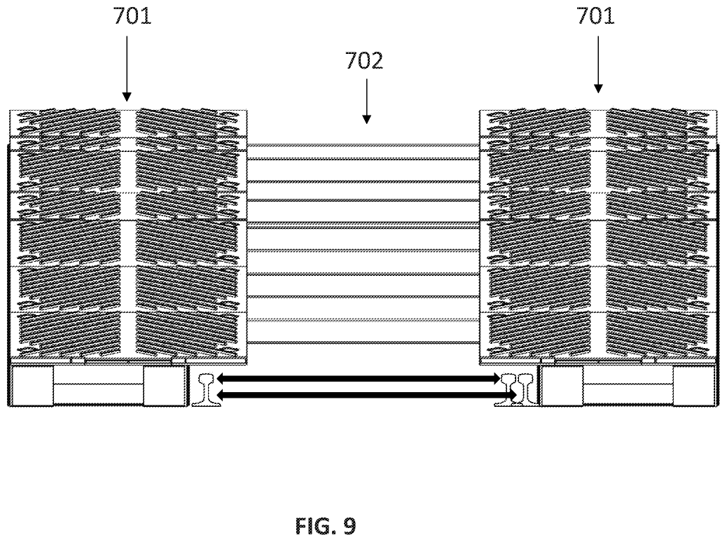

The central bridging sections 702 provide lateral stability between the two main parallel ramp assemblies 701. They are attached using brackets or other fixing methods on the inside faces of the outer ramp modules (see FIG. 9) and permit an operator to gain access therein additionally to the bracing points on the outer ramp sections. By its open design the bracings thereby employed in the additional strengthening of the ramp assembly benefit from being enclosed within the natural void within the structure of the ramp, along with any additional chains or other strapping, and thereby do not present an impediment or interference with vehicular movement or a tripping hazard to operators working in the vicinity. Furthermore, the central bridging supports may provide structural stability and support to the upper surface wedges 1302 when vehicles traversing the ramp apply force to the wedges at their innermost surface, thereby counteracting rotational forces on the main ramp system through their design.

The main parallel ramp assemblies 701 sit adjacent to, and outside of, the rail tracks FIG. 9 according to one embodiment and are configured to accommodate the most common global rail track gauges of both ‘standard’ (US & European) gauge of about 1435 mm and ‘broad’ gauge (about 1520 mm). The offset defined by the central bridging supports permits the ramp to be used for both gauges without interference with the rail track itself.

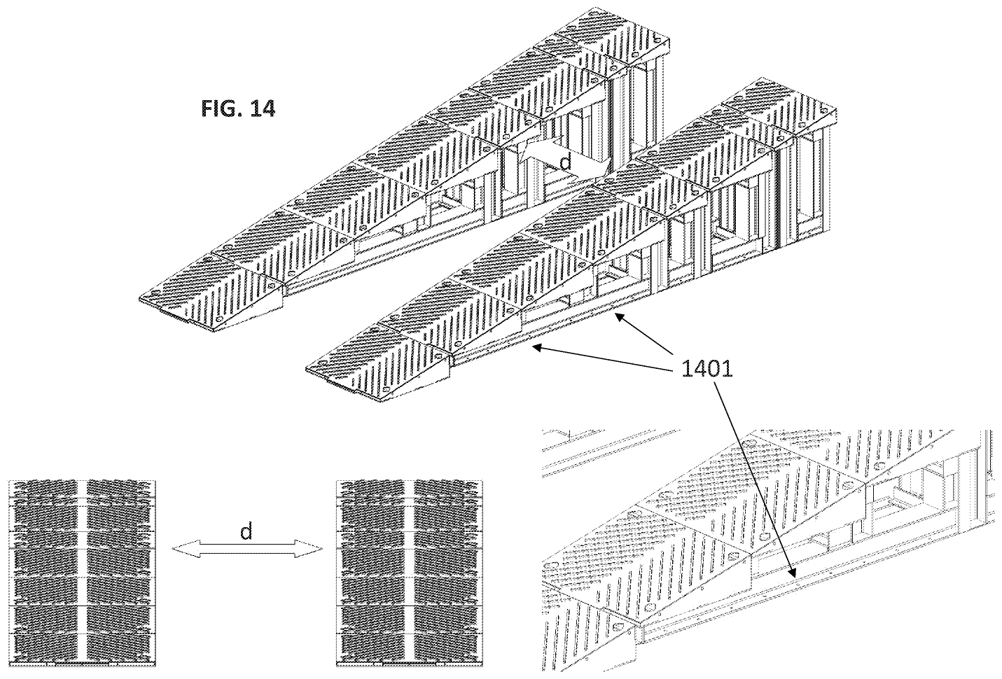

The ramp system may also be used outside of rail track environments in a yard configuration to load/offload transport trailers FIG. 6 and the ramp system can thereby be sited to support different track widths FIG. 14 by varying the internal spacing “d” between the parallel ramp tracks, with the possibility to eliminate the central bridging supports if the ramps are affixed to the floor using optionally the anchoring holes provided 1401. Such a simplification offers ability to utilize the ramp system additionally for other activities, such as vehicle underbody inspection, which benefits from an open internal void between the parallel ramp tracks.

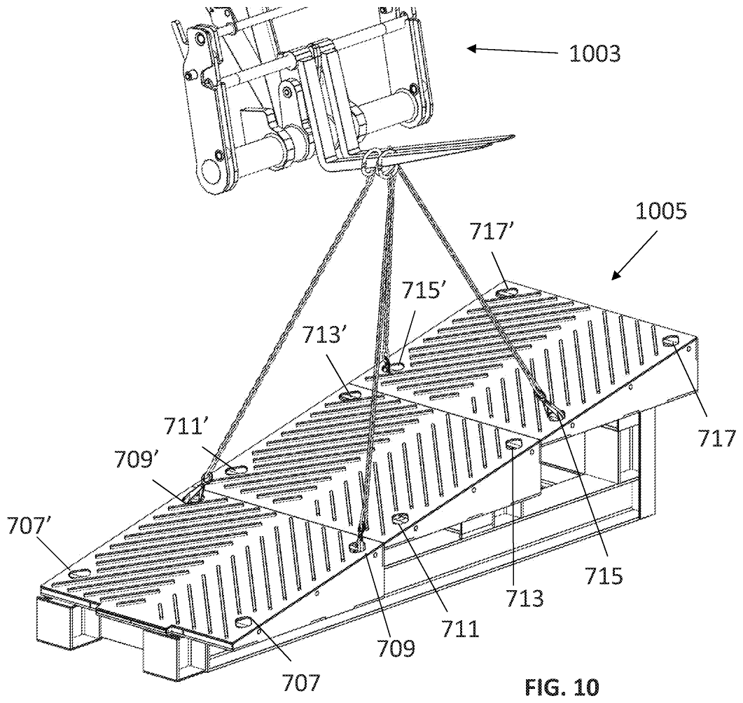

Each ramp section is designed to be flexibly lifted into position by various methods and devices 1003, and to that end each section comprises at a minimum two slinging points (for example 707, 707′, 709, 709′, 711, 711′ and 713, 713′) on the upper surface FIG. 10 as well as forklift lifting pockets or slots where such space permits. Such slinging points are integral to the design and may comprise a solid structural bar affixed to the underside of the lifting surface which by design cannot move within the assembly, and with a structural lifting capacity considerably in excess of the section's own self-weight. Said slinging points may have slots in the upper deck surface to allow for easier reach of the operator attaching/detaching the lifting slings/chains.

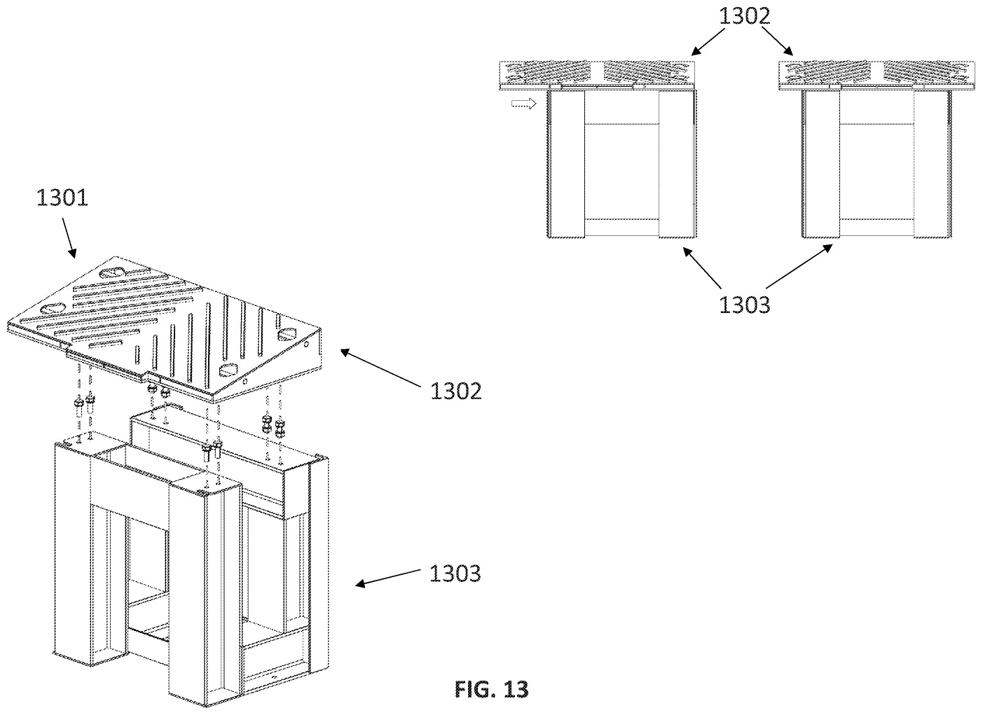

Referring now to FIG. 13, each main ramp module 1301 is constructed by bolted or pinned connection of a structural base frame system 1303 to an angled wedge 1302 that comprises the load supporting surface. By virtue of the design, this structural wedge 1302 may be positioned such to cantilever (as shown by arrow) the driving surface over its supporting base frame 1303 and into position partially over the rail track, while the base frames 1303 are limited as to their resting position on the ground by the rail track. Such a simplification provides a narrower inside driving surface for vehicles with lesser wheel track than larger armored vehicles with larger wheel track. In an alternative attachment, the wedges can be re-bolted in a different manner such that they are centrally positioned over the base-frame 1303 which may be optimal for when the ramp system is used as a fixed yard ramp.

While specific embodiments of the invention have been shown and described in detail to illustrate the inventive principles, it will be understood that the invention may be embodied otherwise without departing from such principles.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. The assembled modular ramp system comprises:
a first outer ramp track;
a second outer ramp track; and
a central bridging support that connects the first outer ramp track with the second outer ramp track,
wherein the first outer ramp track and the second outer ramp track comprise a plurality of ramp modules having differing vertical lifts such that the first outer ramp track and the second outer ramp track have a like sequence of vertical lifts provided by the plurality of ramp modules that decrease from a height of about a loading dock to about the off-loading surface and
wherein a ramp module of the plurality of ramp modules is configured to interlock with an adjoining ramp module, and
wherein the central bridging support comprises one or more support members that connect a ramp module of height x positioned in the first outer ramp track to a ramp module of height y positioned in the second outer ramp track to stabilize the assembled modular ramp system.

2. The ramp system of claim 1, wherein the ramp module has one or more pockets to accept forklift tines

3. The ramp system of claim 1, wherein the ramp module has one or more slinging points to which lifting equipment can be attached.

4. The ramp system of claim 1, wherein each ramp module in the first outer ramp track or the second outer ramp track is a different vertical lift as compared to the adjoining ramp module while maintaining at all times the same loading angle.

5. The ramp system of claim 1, wherein the ramp module is comprised of heavy structural steel.

6. The ramp system of claim 1, wherein the upper surface of the ramp module is provided with a slip-resistant coating.

7. The ramp system of claim 1, wherein a lashing/tie-down position is affixed to the ramp system.

8. The ramp system of claim 6, wherein the upper surface is comprised of steel affixed with an arrangement of solid bar sections to increase friction for a vehicle's wheels or tracks.

9. The ramp system of claim 8, wherein the solid bar sections are affixed at an angle other than horizontal to allow for water run off from the upper surface.

10. The ramp system according to claim 8, wherein the ramp module in the disassembled state may be inverted and packed together with an opposing ramp module upper surface to upper surface in their angled planes, wherein the angled solid bar rests and opposes that of a mating ramp module to form a triangular shaped module wherein the triangular shaped modules is prevented from sliding apart.

11. The ramp system of claim 1, wherein the plurality of ramp modules comprise lashing points to securely fasten the plurality of ramp modules together.

12. The ramp system of claim 1 where each support member has a first end and a second end where the first end is connected to the ramp module of height x in the first outer ramp track and the second end is connected to the ramp module of height y in the second outer ramp track with a plurality of pins or other fixing means to avoid rotation of a joint.

13. The ramp system of claim 1 where each ramp module is constructed from a separate base frame and an upper wedge to create an angled upper driving surface.

14. The ramp system of claim 13 where the ramp module wedge is bolted to a separate base frame using a multitude of fixing positions.

15. The ramp system of claim 13 where the ramp module wedge is positioned laterally to move the driving surface relative to the ramp base frame.

16. The ramp system of claim 1 wherein the interlock of adjoining ramp modules comprises a flanged channel guide positioned longitudinally at a lesser side of the ramp module, and over which is positioned an opposing angled section located on a greater side of an adjoining ramp module and wherein the flanged channel guide is configured to enclose over the opposing angled section of the adjoining ramp module, wherein the flanged channel permits vertical travel of an outward facing plate of the opposing angled section within the flanged channel but which prevents the opposing angled section from disconnecting laterally or longitudinally under load without first lifting in the vertical plane of the adjoining ramp module.

17. The ramp system of claim 1 wherein the outer ramp module is laterally connected to each other via an arrangement of structural sections connected back to the modules by brackets presenting latitudinally in the outer ramp modules wherein the bracing members are pinned in place using a plurality of pins at either end to prevent rotation of the connection joint.
